(19) United States
(12) Patent Application Publication
(10) Pub. No.: US 2026/0112698 A1
(43) Pub. Date: Apr. 23, 2026

(54) Lithium Secondary Battery

(71) Applicant: LG Energy Solution, Ltd., Seoul (KR)

(72) Inventors: Chul Eun Yeom, Daejeon (KR); Sung Guk Park, Daejeon (KR); Chul Haeng Lee, Daejeon (KR); Jung Hoon Lee, Daejeon (KR); Jung Min Lee, Daejeon (KR)

(73) Assignee: LG Energy Solution, Ltd., Seoul (KR)

(21) Appl. No.: 19/168,615

(22) PCT Filed: Sep. 13, 2024
(86) PCT No.: PCT/KR2024/014072

§ 371 Date: Sep. 24, 2025

(30) Foreign Application Priority Data
Sep. 21, 2023 (KR) 10-2023-0126665
Sep. 13, 2024 (KR) 10-2024-0125919

(51) Int. Cl. H01M 10/0567; H01M 4/505; H01M 10/052; H01M 10/0569

(52) U.S. Cl. CPC H01M 10/0567; H01M 4/505; H01M 10/052; H01M 10/0569; H01M 2300/004

(57) ABSTRACT

Provided is a lithium secondary battery including a positive electrode; a negative electrode; a separator disposed between the positive electrode and the negative electrode; and a non-aqueous electrolyte, wherein the positive electrode includes a positive electrode active material, the positive electrode material includes a perlithium manganese-rich oxide containing about 50 mol % or more of Mn based on all metal elements excluding lithium, and having a molar ratio of lithium to all transition metals exceeding about 1, and the non-aqueous electrolyte includes a lithium salt, a compound represented by Chemical Formula 1 and a compound represented by Chemical Formula 2:

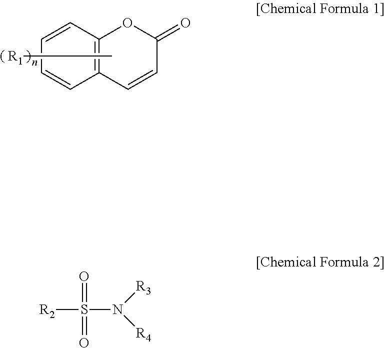

wherein all the variables are described herein.

### CROSS-REFERENCE TO RELATED APPLICATIONS

This application is a national stage entry under 35 U.S.C. § 371 of International Application No. PCT/KR2024/014072 filed on Sep. 13, 2024, which claims priority from Korean Patent Application Nos. 10-2023-0126665 filed on Sep. 21, 2023, and 10-2024-0125919 filed on Sep. 13, 2024, all the disclosures of which are incorporated by reference herein.

### TECHNICAL FIELD

The present disclosure relates to a lithium secondary battery. Particularly, the present disclosure relates to a lithium secondary battery including perlithium manganese-rich oxide as a positive electrode active material.

### BACKGROUND

Recently, as application areas of a lithium secondary battery rapidly expand not only to power supply to electricity, electronics, communication, and electronic devices such as computers, but also to power storage supply to large-area devices such as vehicles or power storage devices, demand for a secondary battery having high capacity and high output, while having high stability, is increasing.

The lithium secondary battery generally includes a positive electrode containing a positive electrode active material, a negative electrode containing a negative electrode active material, an electrolyte serving as a medium for transferring lithium ions, and a separator. At this time, a carbon-based active material, a silicon-based active material, etc. may be used as the negative electrode active material. In addition, as the positive electrode active material, a lithium transition metal oxide, including lithium cobalt oxide (LiCoO₂), lithium nickel oxide (LiNiO₂), lithium nickel-cobalt-manganese composite oxide, etc. may be used.

As the next-generation positive electrode active material, perlithium manganese-rich oxide has recently been attracting attention. The perlithium manganese-rich oxide has an increased amount of manganese (Mn), which is relatively inexpensive and has abundant reserves, and has the advantage of having high capacity. However, due to reactive oxygen generated by phase transformation of the positive electrode active material during formation and charging/discharging processes, decomposition of an electrolyte intensifies and the amount of gas generation significantly increases, and transition metal eluted in the positive electrode active material is electrodeposited on a negative electrode, causing a problem of destroying a SEI film of the negative electrode, and therefore, the use of the perlithium manganese-rich oxide has been limited. This is more problematic particularly in high-temperature and high-voltage operation.

### Technical Problem

A task of the present disclosure is to solve the above-described problem, and is to provide a lithium secondary battery including perlithium manganese-rich oxide as a positive electrode active material, wherein gas generation is reduced during the initial formation and charging/discharging, and elution of transition metal in the positive electrode active material is suppressed, so that high-temperature cycle characteristics and high-temperature storage characteristics are excellent.

### Technical Solution

[1] The present disclosure provides a lithium secondary battery including a positive electrode; a negative electrode; a separator disposed between the positive electrode and the negative electrode; and a non-aqueous electrolyte, wherein the positive electrode material includes a perlithium manganese-rich oxide containing about 50 mol % or more of Mn based on all metal elements excluding lithium, and having a molar ratio of lithium to transition metal exceeding about 1, and the non-aqueous electrolyte includes a lithium salt, a compound represented by Chemical Formula 1 below, and a compound represented by Chemical Formula 2 below.

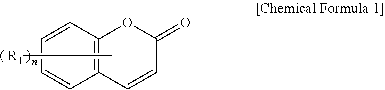

In Chemical Formula 1 above, R₁ each independently includes a halogen, a nitrile group, a propargyl group, an ester group, an ether group, a ketone group, a carboxyl group, a substituted or unsubstituted alkyl group, a substituted or unsubstituted alkenyl group, a substituted or unsubstituted alkynyl group, a substituted or unsubstituted alkoxy group, a boron group, a borate group, an isocyanate group, an isothiocyanate group, a silyl group, a siloxane group, a sulfone group, a sulfonate group, a sulfate group, or a combination of two or more thereof, and n is an integer of 0 to 6.

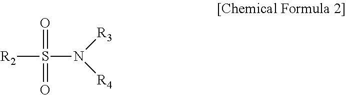

In Chemical Formula 2 above, R₂ is fluorine, a C1 to C10 alkyl group substituted with one or more fluorine, a C1 to C10 alkoxy group substituted with one or more fluorine, or a C6 to C20 aryloxy group substituted with one or more fluorine, and R₃ and R₄ are each independently hydrogen, a C1 to C10 alkyl group, or a C6 to C20 aryl group.

[2] The present disclosure provides the lithium secondary battery of [1] above, wherein the perlithium manganese-rich oxide includes a compound represented by Chemical Formula A below.

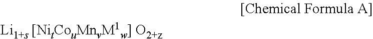

In Chemical Formula A above, M¹ is one or more selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and 0.05≤s≤1, 0≤t≤0.5, 0≤u≤0.3, 0.5≤v<1.0, 0≤w≤0.2, and 0≤z≤1.

[3] The present disclosure provides the lithium secondary battery of at least one of [1] or [2] above, wherein the compound represented by Chemical Formula 1 above includes at least one of a compound represented by Chemical Formula 1-A below or a compound represented by Chemical Formula 1-B below.

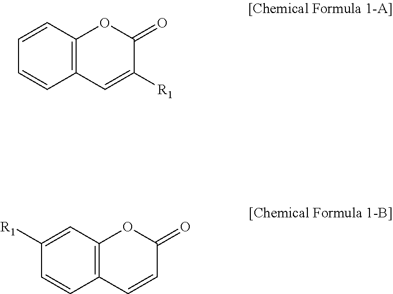

In Chemical Formula 1-A and Chemical Formula 1-B above, R₁ is as defined by Chemical Formula 1 above.

[4] The present disclosure provides the lithium secondary battery of at least one of [1] to [3] above, wherein the compound represented by Chemical Formula 1 above includes at least one of compounds represented by Chemical Formula 1-1 to Chemical Formula 1-9 below.

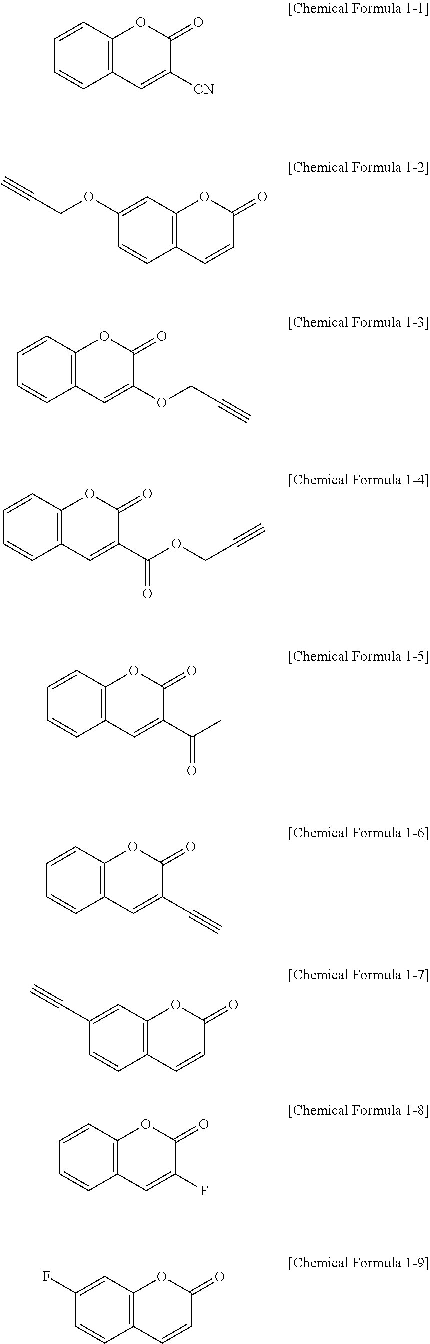

[5] The present disclosure provides the lithium secondary battery of at least one of [1] to [4] above, wherein the compound represented by Chemical Formula 1 above is included in an amount of 0.01 wt % to 10 wt % based on a total weight of the non-aqueous electrolyte.

[6] The present disclosure provides the lithium secondary battery of at least one of [1] to [5] above, wherein the compound represented by Chemical Formula 2 above includes at least one of compounds represented by Chemical Formula 2-1 to Chemical Formula 2-5 below.

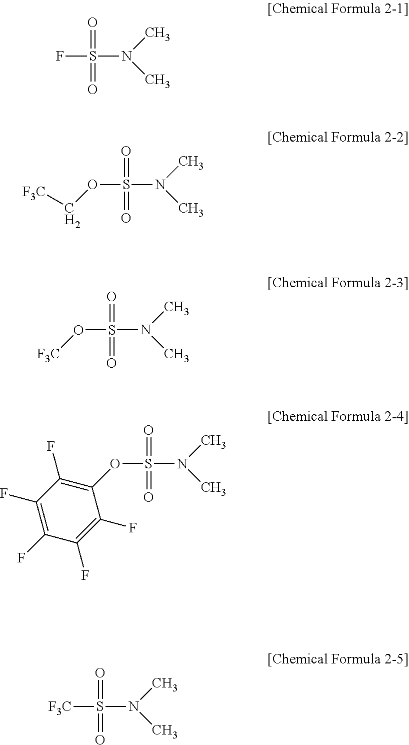

[7] The present disclosure provides the lithium secondary battery of at least one of [1] to [6] above, wherein the compound represented by Chemical Formula 2 above is included in an amount of 5 wt % to 40 wt % in the non-aqueous electrolyte.

[8] The present disclosure provides the lithium secondary battery of at least one of [1] to [7] above, wherein a weight ratio of the compound represented by Chemical Formula 1 above and the compound represented by Chemical Formula 2 above is 0.01:99.1 to 50:50.

[9] The present disclosure provides the lithium secondary battery of at least one of [1] to [8] above, wherein the lithium salt includes at least one of LiCl, LiBr, LiI, LiBF₄, LiClO₄, LiAlO₄, LiAlCl₄, LiPF₆, LiSbF₆, LiAsF₆, LiB₁₀Cl₁₀, LiB(C₂O₄)₂ (LiBOB), LiCF₃SO₃, LiN(SO₂F)₂ (LiFSI), LiCH₃SO₃, LiCF₃CO₂, LiCH₃CO₂, or LiN(SO₂CF₂CF₃)₂ (LiBETI).

[10] The present disclosure provides the lithium secondary battery of at least one of [1] to [9] above, wherein the non-aqueous electrolyte includes an organic solvent, and the organic solvent includes at least one of a cyclic carbonate-based organic solvent, a linear carbonate-based organic solvent, a linear ester-based organic solvent, or a cyclic ester-based organic solvent.

[11] The present disclosure provides the lithium secondary battery of at least one of [1] to [10] above, wherein the non-aqueous electrolyte further includes at least one additive of vinylene carbonate, vinylethylene carbonate, fluoroethylene carbonate, propane sultone, propene sultone, succinonitrile, adiponitrile, ethylene sulfate, lithium bis-(oxalato)borate (LiBOB), lithium difluorooxalatoborate (LiODFB), tris(trimethylsilyl) phosphate (TMSPa), or tris(trimethylsilyl) phosphite (TMSPi).

### Advantageous Effects

A lithium secondary battery of the present disclosure is characterized by using perlithium manganese-rich oxide as a positive electrode active material, and using the compound represented by Chemical Formula 1 above and the compound represented by Chemical Formula 2 above as components of a non-aqueous electrolyte. The compound represented by Chemical Formula 1 above is a coumarin-based compound, which scavenges reactive oxygen during initial formation to prevent consumption of an organic solvent in the non-aqueous electrolyte, and to prevent gas generation caused by decomposition of the organic solvent. In addition, the compound represented by Chemical Formula 2 above is a sulfonamide-based compound, which may secure oxidation stability of the non-aqueous electrolyte to suppress battery deterioration caused by gas generation during charging and discharging. Accordingly, in case of using the compound represented by Chemical Formula 1 above in combination with the compound represented by Chemical Formula 2 above, gas generation may be reduced during the initial formation and charging/discharging of the lithium secondary battery including the perlithium manganese-rich oxide, and elution of transition metal in the positive electrode active material may be suppressed, so that the lithium secondary battery may have significantly improved high-temperature cycle characteristics and high-temperature storage characteristics.

### DETAILED DESCRIPTION

It will be understood that terms or words used in the specification and claims shall not be interpreted as the meaning defined in commonly used dictionaries, and it will be further understood that the terms or words should be interpreted as having a meaning or concept that is consistent with the technical idea of the present invention, based on the principle that an inventor may properly define the meaning of the terms or words to best explain the invention.

It will be further understood that the terms “include”, “provide”, “have”, or the like, when used in this specification, specify the presence of stated features, integers, steps, elements, or a combination thereof, but do not preclude the presence or addition of one or more other features, integers, steps, elements, or a combination thereof.

Meanwhile, before explaining the present disclosure, unless specially noted in the present disclosure, “*” refers to a connected portion (binding part) between the same or different atoms or end portions of a chemical formula.

In addition, in the specification, in the term “Ca to Cb”, “a” and “b” refer to the number of carbon atoms included in a particular functional group. That is, the functional group may include “a” to “b” carbon atoms. For example, “C1 to C5 alkyl group” refers to an alkyl group including 1 to 5 carbon atoms, which is CH₃—, CH₃CH₂—, CH₃CH₂CH₂—, (CH₃)₂CH—, CH₃CH₂CH₂CH₂—, (CH₃)₂CHCH₂—, CH₃CH₂CH₂CH₂CH₂—, (CH₃)₂CHCH₂CH₂—, etc.

In addition, in this specification, an alkyl group or aryl group may each be substituted or unsubstituted. Unless specially defined otherwise, the “substitution” refers to at least one hydrogen, bound to carbon, being substituted with an element other than hydrogen, which refers to being substituted with, for example, a C1 to C20 alkyl group, a C2 to C20 alkenyl group, a C2 to C20 alkynyl group, a C1 to C20 alkoxy group, a C3 to C12 cycloalkyl group, a C3 to C12 cycloalkenyl group, a C3 to C12 heterocycloalkyl group, a C3 to C12 heterocycloalkenyl group, a C6 to C12 aryloxy group, a halogen atom, a C1 to C20 fluoroalkyl group, a nitro group, a C6 to C20 aryl group, a C2 to C20 hetero aryl group, a C6 to C20 haloaryl group, etc.

Hereinafter, the present disclosure will be described in more detail.

A non-aqueous electrolyte and/or a lithium secondary battery according to the present disclosure may include at least one among components disclosed below, and may include any combination of components, technically possible, among the components below.

### Lithium Secondary Battery

The present disclosure relates to a lithium secondary battery.

A lithium secondary battery according to the present disclosure includes a positive electrode; a negative electrode; a separator disposed between the positive electrode and the negative electrode; and a non-aqueous electrolyte, the positive electrode includes a positive electrode active material, the positive electrode material includes a perlithium manganese-rich oxide containing about 50 mol % or more of Mn based on all metal elements excluding lithium, and having a molar ratio of lithium to transition metal exceeding about 1, and the non-aqueous electrolyte includes a lithium salt, a compound represented by Chemical Formula 1 below, and a compound represented by Chemical Formula 2 below.

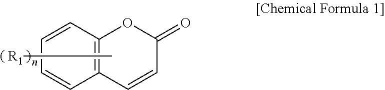

In Chemical Formula 1 above, R₁ each independently includes a halogen, a nitrile group, a propargyl group, an ester group, an ether group, a ketone group, a carboxyl group, a substituted or unsubstituted alkyl group, a substituted or unsubstituted alkenyl group, a substituted or unsubstituted alkynyl group, a substituted or unsubstituted alkoxy group, a boron group, a borate group, an isocyanate group, an isothiocyanate group, a silyl group, a siloxane group, a sulfone group, a sulfonate group, a sulfate group, or a combination of two or more thereof, and n is an integer of 0 to 6.

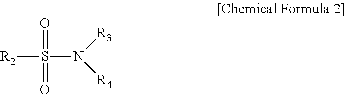

In Chemical Formula 2 above, R₂ is fluorine, a C1 to C10 alkyl group substituted with one or more fluorine, a C1 to C10 alkoxy group substituted with one or more fluorine, or a C6 to C20 aryloxy group substituted with one or more fluorine, and R₃ and R₄ are each independently hydrogen, a C1 to C10 alkyl group, or a C6 to C20 aryl group.

The lithium secondary battery of the present disclosure is characterized by using perlithium manganese-rich oxide as a positive electrode active material, and using the compound represented by Chemical Formula 1 above and the compound represented by Chemical Formula 2 above as components of the non-aqueous electrolyte. The compound represented by Chemical Formula 1 above is a coumarin-based compound, which scavenges reactive oxygen during initial formation to prevent consumption of an organic solvent in the non-aqueous electrolyte, and to prevent gas generation caused by decomposition of the organic solvent. In addition, the compound represented by Chemical Formula 2 above is a sulfonamide-based compound, which may secure oxidation stability of the non-aqueous electrolyte to suppress battery deterioration caused by gas generation during charging and discharging. Accordingly, in case of using the compound represented by Chemical Formula 1 above in combination with the compound represented by Chemical Formula 2 above, gas generation may be reduced during the initial formation and charging/discharging of the lithium secondary battery including the perlithium manganese-rich oxide, and elution of transition metal in the positive electrode active material may be suppressed, so that the lithium secondary battery may have significantly improved high-temperature cycle characteristics and high-temperature storage characteristics.

The lithium secondary battery includes a positive electrode; a negative electrode; a separator; and a non-aqueous electrolyte. In particular, the lithium secondary battery includes a positive electrode; a negative electrode opposed to the positive electrode; a separator disposed between the positive electrode and the negative electrode; and a non-aqueous electrolyte. The lithium secondary battery may be prepared by accommodating an electrode assembly, which includes the positive electrode; the negative electrode opposed to the positive electrode; and the separator disposed between the positive electrode and the negative electrode, in a battery case, and then injecting the non-aqueous electrolyte thereto.

### (1) Positive Electrode

The positive electrode includes a positive electrode active material.

the positive electrode material includes a perlithium manganese-rich oxide. the perlithium manganese-rich oxide may contain about 50 mol % or more of Mn based on all metal elements excluding lithium, and may have a molar ratio of lithium to transition metal exceeding about 1.

The perlithium manganese-rich oxide receives attention as a next-generation high-capacity positive electrode active material, but due to structural deterioration unique to the material, its use is being limited. In particular, reactive oxygen, deintercalated from the perlithium manganese-rich oxide during initial formation, decomposes and consumes an organic solvent (ethylene carbonate, etc.) included in the non-aqueous electrolyte, and accordingly, gas by-products are generated, thereby causing the problems of deteriorating lifetime performance, increasing resistance, and deteriorating safety. In addition, in the process of charging and discharging of the lithium secondary battery including the perlithium manganese-rich oxide, HF, which is a decomposition product of a lithium salt, may cause elution of manganese of the perlithium manganese-rich oxide, and accordingly, there is a problem of deintercalating oxygen, particularly reactive oxygen, from the perlithium manganese-rich oxide for achieving the charge balance. The eluted manganese is electrodeposited on the negative electrode, causing a problem of destroying a SEI film, the reactive oxygen, deintercalated during the process of charging and discharging, continuously decomposes and consumes the organic solvent of the non-aqueous electrolyte, increasing generation of the gas by-products. Such consumption of the non-aqueous electrolyte, structural collapse of the perlithium manganese-rich oxide, and the increase in gas by-products significantly deteriorate lifetime performance, resistance characteristics, and safety of the lithium secondary battery. In addition, such problems intensify further under high-temperature and high-voltage conditions.

To solve these problems, the lithium secondary battery according to the present disclosure is characterized by using the compound represented by Chemical Formula 1 in combination with the compound represented by Chemical Formula 2, to be described later, as non-aqueous electrolyte components. In case of using the compound represented by Chemical Formula 1 above and the compound represented by Chemical Formula 2 above at the same time, generation of reactive oxygen may be significantly suppressed in the processes of initial formation and operation of the lithium secondary battery, structural collapse of the perlithium manganese-rich oxide may be prevented, and the consumption of the organic solvent may be significantly prevented, so that it is possible to achieve the lithium secondary battery having excellent high-temperature cycle characteristics, high-temperature storage characteristics, and safety. Such effects are difficult to achieve with another lithium transition metal oxide, where deintercalation of reactive oxygen is not a major problem, and rather, increase in initial resistance and decrease in lifetime performance, caused by using the compounds represented by Chemical Formula 1 and Chemical Formula 2, may be the problems.

The perlithium manganese-rich oxide may include a compound represented by Chemical Formula A below.

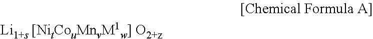

In Chemical Formula A above, M¹ is one or more selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and 0.05≤s≤1, 0≤t≤0.5, 0≤u≤0.3, 0.5≤v<1.0, 0≤w≤0.2, and 0≤z≤1. Preferably, in Chemical Formula A above, 0.05≤s≤1.0, 0.1≤t≤0.5, 0≤u≤0.1, 0.5≤v<1.0, 0≤w≤0.2, and 0≤z≤1 may be satisfied. More preferably, in Chemical Formula A above, 0.10≤s≤0.50, 0.1≤t≤0.5, 0≤u≤0.1, 0.6≤v<1.0, 0≤w≤0.1, and 0≤z≤0.50 may be satisfied.

More particularly, the perlithium manganese-rich oxide may include a compound represented by Chemical Formula A-1 below.

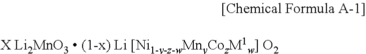

In Chemical Formula A-1 above, M¹ is one or more selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo. In addition, in Chemical Formula A-1 above, 0.1≤X≤0.5, 0.5≤y<1, 0≤z≤0.3, and 0≤w≤0.2 may be satisfied, preferably, 0.2≤X≤0.5, 0.5≤y<1, 0≤z≤0.1, and 0≤w≤0.2, and more preferably, 0.3≤X≤0.5, 0.6≤y<1, 0≤z≤0.1, and 0≤w≤0.2 may be satisfied.

The positive electrode may include a positive electrode current collector; and a positive electrode active material layer disposed on at least one side of the positive electrode current collector. At this time, the positive electrode active material may be included in the positive electrode active material layer.

The positive electrode current collector is not particularly limited as long as it does not cause chemical change in a battery, and has high conductivity. In particular, the positive electrode current collector may include at least one of copper, stainless steel, aluminum, nickel, titanium, calcined carbon, or an aluminum-cadmium alloy, and may preferably include aluminum.

The positive electrode current collector may generally have a thickness of 3 to 500 μm.

The positive electrode current collector may also have microscopic irregularities on a surface to strengthen binding force of the positive electrode active material. For example, the positive electrode current collector may be used in various forms including a film, a sheet, a foil, a net, a porous body, a foam body, a non-woven fiber body, etc.

The positive electrode active material layer may be disposed on at least one side of the positive electrode current collector, and particularly, disposed on one side or both sides of the positive electrode current collector.

The positive electrode active material may be included in an amount of 80 wt % to 99 wt %, and preferably in an amount of 92 wt % to 98.5 wt % in the positive electrode active material layer in consideration of exhibition of sufficient capacity of the positive electrode active material, etc.

The other descriptions on the positive electrode active material previously described will be omitted.

The positive electrode active material layer may further include a binder and/or a conductive material, together with the positive electrode active material.

The binder is a component that assists binding between the active material and the conductive material, etc., and binding to the current collector, and may include at least one of, specifically, polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene ter polymer (EPDM), a sulfonated EPDM, a styrene-butadiene rubber, or fluorine rubber, and may preferably include polyvinylidene fluoride.

The binder may be included in an amount of 1 wt % to 20 wt %, and preferably in an amount of 1.2 wt % to 10 wt % in the positive electrode active material layer in terms of securing sufficient binding force between the components such as the positive electrode active material.

The conductive material may be used to assist and improve conductivity of the secondary battery, and is not particularly limited as long as it does not cause chemical change and has conductivity. Specifically, the positive electrode conductive material may include at least one of graphite such as natural graphite or artificial graphite; carbon black including carbon black, acetylene black, ketjen black, channel black, furnace black, lamp black, thermal black, etc.; a conductive fiber such as a carbon fiber or a metal fiber; a conductive tube such as a carbon nanotube; fluorocarbon; metal powder including aluminum powder, nickel powder, etc.; a conductive whisker including zinc oxide, potassium titanate, etc.; a conductive metal oxide such as titanium oxide; or a polyphenylene derivative, and may preferably include a carbon nanotube in terms of improving conductivity.

The conductive material may be included in an amount of 1 wt % to 20 wt %, and preferably in an amount of 1.2 wt % to 10 wt % in the positive electrode active material layer in terms of securing sufficient electrical conductivity.

The positive electrode active material layer may have a thickness of 30 μm to 400 μm, and preferably 40 μm to 110 μm.

A positive electrode slurry, including the positive electrode active material, selectively the binder and the conductive material, and a solvent for forming the positive electrode slurry, may be applied onto the positive electrode current collector, and then dried and pressed to prepare the positive electrode.

The solvent for forming the positive electrode slurry may include an organic solvent such as N-methyl-2-pyrrolidone (NMP). The positive electrode slurry may have a solid content of 40 wt % to 90 wt %, and particularly 50 wt % to 80 wt %.

### (2) Negative Electrode

The negative electrode may be opposed to the positive electrode.

The negative electrode includes a negative electrode active material.

The negative electrode active material is a material capable of reversibly intercalating/deintercalating lithium ions, and may include at least one of a carbon-based active material, a (semi) metal-based active material, or lithium metal, and may specifically include at least one of a carbon-based active material or a (semi) metal-based active material.

The carbon-based active material may include at least one of artificial graphite, natural graphite, hard carbon, soft carbon, carbon black, graphene, or fibrous carbon, and may preferably include at least one of artificial graphite or natural graphite.

The carbon-based active material may have an average particle diameter (D₅₀) of 10 μm to 30 μm, and preferably 15 μm to 25 μm in terms of improving structural stability and reducing side reactions with an electrolyte solution during charging and discharging.

In particular, the (semi) metal-based active material may include at least one (semi) metal of Cu, Ni, Na, K, Rb, Cs, Fr, Be, Mg, Ca, Sr, Si, Sb, Pb, In, Zn, Ba, Ra, Ge, Al, V, Ti, or Sn; an alloy of lithium and at least one (semi) metal of Cu, Ni, Na, K, Rb, Cs, Fr, Be, Mg, Ca, Sr, Si, Sb, Pb, In, Zn, Ba, Ra, Ge, Al, V, Ti, or Sn; an oxide of at least one (semi) metal of Cu, Ni, Na, K, Rb, Cs, Fr, Be, Mg, Ca, Sr, Si, Sb, Pb, In, Zn, Ba, Ra, Ge, Al, V, Ti, or Sn; lithium titanium oxide (LTO); lithium vanadium oxide, etc.

More particularly, the (semi) metal-based active material may include a silicon-based active material.

The silicon-based active material may include a compound represented by SiOₓ(0≤x<2) or a silicon-carbon composite. Since SiO₂ does not react to lithium ions, lithium may not be stored, so that it is preferable that x falls within the above range, and it is more preferable that the silicon-based active material may be SiO.

The silicon-based active material may have an average particle diameter (D₅₀) of 1 μm to 30 μm, and preferably 2 μm to 15 μm in terms of improving structural stability and reducing side reactions with an electrolyte solution during charging and discharging.

The negative electrode may include a negative electrode current collector; and a negative electrode active material layer disposed on at least one side of the negative electrode current collector. At this time, the negative electrode active material may be included in the negative electrode active material layer.

The negative electrode current collector is not particularly limited as long as it does not cause chemical change in a battery, and has high conductivity. In particular, copper, stainless steel, aluminum, nickel, titanium, calcined carbon, copper or stainless steel that is surface-treated with carbon, nickel, titanium, silver, etc., an aluminum-cadmium alloy, etc. may be used as the negative electrode current collector.

The negative electrode current collector may generally have a thickness of 3 to 500 μm.

The negative electrode current collector may also have microscopic irregularities on a surface to strengthen binding force of the negative electrode active material. For example, the negative electrode current collector may be used in various forms including a film, a sheet, a foil, a net, a porous body, a foam body, a non-woven fiber body, etc.

The negative electrode active material layer may be disposed on at least one side of the negative electrode current collector, and particularly, disposed on one side or both sides of the negative electrode current collector.

The negative electrode active material may be included in an amount of 60 wt % to 99 wt %, and preferably in an amount of 75 wt % to 95 wt % in the negative electrode active material layer.

The other descriptions on the negative electrode active material previously described will be omitted.

The negative electrode active material layer may further include a binder and/or a conductive material together with the negative electrode active material.

The binder is used to improve performance of a battery by improving adhesion of the negative electrode active material layer to the negative electrode current collector, and may include at least any one of, for example, a polyvinylidene fluoride-hexafluoropropylene copolymer (PVDF-co-HFP), polyvinylidene fluoride (PVDF), polyacrylonitrile, polymethylmethacrylate, polyvinyl alcohol, carboxymethyl cellulose (CMC), starch, hydroxypropyl cellulose, regenerated cellulose, polyvinyl pyrrolidone, polytetrafluoroethylene, polyethylene, polypropylene, polyacrylic acid, an ethylene-propylene-diene monomer (EPDM), a sulfonated EPDM, a styrene-butadiene rubber (SBR), fluorine rubber, or materials with hydrogen thereof being substituted with Li, Na, Ca, or the like, and may also include various copolymers thereof.

The binder may be included in an amount of 0.5 wt % to 10 wt %, and preferably 1 wt % to 5 wt % in the negative electrode active material layer.

The conductive material may not be particularly limited as long as it does not cause chemical change in the relevant battery and has conductivity, and for example, graphite such as natural graphite or artificial graphite; carbon black including carbon black, acetylene black, ketjen black, channel black, furnace black, lamp black, thermal black, etc.; a conductive fiber such as a carbon fiber or metal fiber; a conductive tube such as a carbon nanotube; fluorocarbon; metal powder including aluminum power, nickel powder, etc.; a conductive whisker including zinc oxide, potassium titanate, etc.; a conductive metal oxide such as titanium oxide; a conductive material such as a polyphenylene derivative, etc. may be used.

The conductive material may be included in an amount of 0.5 wt % to 10 wt %, and preferably in an amount of 1 wt % to 5 wt % in the negative electrode active material layer.

The negative electrode active material layer may have a thickness of 10 μm to 200 μm, and preferably 20 μm to 150 μm.

A negative electrode slurry, including the negative electrode active material, the binder, the conductive material, and/or a solvent for forming the negative electrode slurry, may be applied onto at least one side of the negative electrode current collector, and then dried and pressed to prepare the negative electrode.

The solvent for forming the negative electrode slurry may include at least one of distilled water, N-methyl-2-pyrrolidone (NMP), ethanol, methanol, or isopropyl alcohol, and may preferably include distilled water, in terms of, for example, facilitating dispersion of the negative electrode active material, the binder, and/or the conductive material. The negative electrode slurry may have a solid content of 30 wt % to 80 wt %, and particularly 40 wt % to 70 wt %.

### (3) Separator

The separator may be disposed between the positive electrode and the negative electrode.

In addition, as the separator, a general porous polymer film conventionally used as a separator, for example, a porous polymer film made of a polyolefin-based polymer such as an ethylene homopolymer, a propylene homopolymer, an ethylene/butene copolymer, an ethylene/hexene copolymer, and an ethylene/methacrylate copolymer may be used alone, or used in a lamination thereof, or a general porous non-woven fiber, for example, a non-woven fiber made of glass fiber with high melting point, a polyethylene terephthalate fiber, etc. may be used, but the present disclosure is not limited thereto. Furthermore, a coated separator including a ceramic component or a polymer material may also be used in order to secure heat resistance or mechanical strength, and may be selectively used in a single-layer or multi-layer structure.

### (4) Non-Aqueous Electrolyte

The non-aqueous electrolyte according to the present disclosure includes a lithium salt, a compound represented by Chemical Formula 1 below, and a compound represented by Chemical Formula 2 below. The non-aqueous electrolyte may further include an organic solvent and an additive depending on the case. At this time, the terms of the organic solvent and the additive are used in order to distinguish between the compound represented by Chemical Formula 1 above and the compound represented by Chemical Formula 2 above.

### 1) Lithium Salt

As the lithium salt used in the present disclosure, various lithium salts that are generally used for a non-aqueous electrolyte for a lithium secondary battery may be used without limitation. For example, the lithium salt may include Li⁺ as a positive ion, and may include, as a negative ion, at least any one of F⁻, Cl⁻, Br⁻, I⁻, NO₃⁻, N(CN)₂⁻, BF₄⁻, ClO₄⁻, AlO₄⁻, AlCl₄⁻, PF₆⁻, SbF₆⁻, AsF₆⁻, B₁₀Cl₁₀⁻, BF₂C₂O₄⁻, BC₄O₈⁻, PF₄C₂O₄⁻, PF₂C₄O₈⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, C₄F₉SO₃⁻, CF₃CF₂SO₃⁻, (FSO₂)₂N⁻, CF₃CF₂ (CF₃)₂CO⁻, (CF₃SO₂)₂CH⁻, CH₃SO₃⁻, CF₃(CF₂)₇SO₃⁻, CF₃CO₂⁻, CH₃CO₂⁻, SCN⁻, or (CF₃CF₂SO₂)₂N⁻.

In particular, the lithium salt may include at least one of LiCl, LiBr, LiI, LiBF₄, LiClO₄, LiAlO₄, LiAlCl₄, LiPF₆, LiSbF₆, LiAsF₆, LiB₁₀Cl₁₀, LiB(C₂O₄)₂ (LiBOB), LiCF₃SO₃, LiN(SO₂F)₂ (LiFSI), LiCH₃SO₃, LiCF₃CO₂, LiCH₃CO₂, or LiN(SO₂CF₂CF₃)₂ (LiBETI). In particular, the lithium salt may include at least one of LiBF₄, LiClO₄, LiPF₆, LiB(C₂O₄)₂ (LiBOB), LiCF₃SO₃, LiN(SO₂CF₃)₂ (LiTFSI), LiN(SO₂F)₂ (LiFSI), or LiN(SO₂CF₂CF₃)₂ (LiBETI).

The lithium salt may be included in the non-aqueous electrolyte with a concentration of 0.5 M to 5 M, and particularly with a concentration of 0.8 M to 4 M, and more particularly, with a concentration of 0.8 M to 2.0 M. When the concentration of the lithium salt falls within the above ranges, Li⁺ transference number and the degree of dissociation of the lithium ions may be improved, so that output characteristics of a battery may be improved.

Alternatively, the lithium salt may be included in the non-aqueous electrolyte as a component of the non-aqueous electrolyte, for example, as a residue excluding the compound represented by Chemical Formula 1, the compound represented by Chemical Formula 2, selectively an organic solvent, and an additive.

### 2) Compound Represented by Chemical Formula 1

The non-aqueous electrolyte of the present disclosure includes a compound represented by Chemical Formula 1 below.

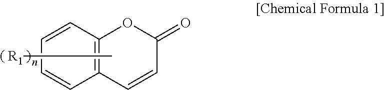

In Chemical Formula 1 above, R₁ each independently includes a halogen, a nitrile group, a propargyl group, an ester group, an ether group, a ketone group, a carboxyl group, a substituted or unsubstituted alkyl group, a substituted or unsubstituted alkenyl group, a substituted or unsubstituted alkynyl group, a substituted or unsubstituted alkoxy group, a boron group, a borate group, an isocyanate group, an isothiocyanate group, a silyl group, a siloxane group, a sulfone group, a sulfonate group, a sulfate group, or a combination of two or more thereof, and n is an integer of 0 to 6.

The compound represented by Chemical Formula 1 above is a coumarin-based compound, which may capture reactive oxygen deintercalated from perlithium manganese-rich oxide during initial formation. Accordingly, use of the compound represented by Chemical Formula 1 above may prevent decomposition of the organic solvent and increase in generation of gas by-products, which might be caused by the reactive oxygen generated during the initial formation process.

In addition, the compound represented by Chemical Formula 1 above may be ring-opened during the initial formation to form a polyethylene oxide-based polymer-type film on an electrode, and such polymer-type film is excellent in flexibility and restorability. In particular, since an inorganic-type film such as LiF, formed by decomposition of the compound represented by Chemical Formula 2 to be described later, is combined with the polymer-type film, the non-aqueous electrolyte of the present disclosure includes both organic/inorganic components, and a film with improved flexibility, restorability, and durability at the same time may be formed on the electrode, thereby further improving high-temperature lifetime characteristics and high-temperature storage characteristics.

However, aside from being capable of removing reactive oxygen during the initial formation process, the compound represented by Chemical Formula 1 above is not effective in removing reactive oxygen generated during charging/discharging or storing of the lithium secondary battery. Such reactive oxygen generated during the charging/discharging or storing of the lithium secondary battery is a by-product of reaction with the electrolyte, which generates H₂O when decomposing a lithium salt and generating HF, and such HF causes elution of manganese from the perlithium manganese-rich oxide and deintercalation of oxygen, thereby accelerating deterioration of lifetime performance and storage performance. To solve these problems, in the present disclosure, by using the compound represented by Chemical Formula 1 above in combination with the compound represented by Chemical Formula 2 above, HF generated during the conditions of charging/discharging, storing, etc. may be removed, so that the possibility of generating reactive oxygen during the charging/discharging, storage, etc. of the lithium secondary battery may be prevented. Therefore, in the present disclosure, since the compound represented by Chemical Formula 1 above and the compound represented by Chemical Formula 2 above are used at the same time, generation of reactive oxygen that is particularly problematic in the perlithium manganese-rich oxide may be controlled, the lifetime performance, storage performance, and safety of the lithium secondary battery may be improved at the same time, and particularly, the lifetime performance, storge performance, and safety in a high-temperature and high-voltage operation may be improved to a significant level.

In Chemical Formula 1, R₁ may be each independently particularly a halogen (halogen may be selected from F, Cl, Br, and I, and particularly, may be F), a nitrile group, a propargyl group, an ester group, an ether group, or a combination of two or more thereof. Such substituent may improve reducibility of the compound represented by Chemical Formula 1 above, and thus, together with the capability of capturing reactive oxygen, effects of facilitating formation of a SEI film and improving performance of transferring lithium ions may also be achieved.

In Chemical Formula 1 above, n may be an integer selected from 0 to 6, and particularly, an integer selected from 1 to 6, and more particularly, n may be 1. In Chemical Formula 1 above, when n is 2 or greater, R₁ may be the same as or different from each other.

In particular, the compound represented by Chemical Formula 1 above may include at least one of a compound represented by Chemical Formula 1-A below or a compound represented by Chemical Formula 1-B below.

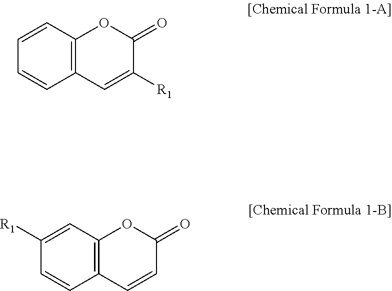

In Chemical Formula 1-A and Chemical Formula 1-B above, R₁ is as defined by Chemical Formula 1 above.

The compounds represented by Chemical Formula 1-A and Chemical Formula 1-B above have structures where substituents exist respectively at the third and seventh positions of ring structures (according to the IUPAC nomenclature), and in this case, it is preferable in that synthesizing at the above positions is more advantageous than at the other substitution positions.

In particular, the compound represented by Chemical Formula 1 above may include at least one of compounds represented by Chemical Formula 1-1 below to Chemical Formula 1-9 below. In terms of smoother reduction to a negative electrode and being more advantageous in forming the SEI film, the compound represented by Chemical Formula 1 above may include at least one of, particularly, the compounds represented by Chemical Formula 1-1 to Chemical Formula 1-4 below, or Chemical Formula 1-6 and Chemical Formula 1-8 below, more particularly, may include at least one of the compounds represented by Chemical Formula 1-1 or Chemical Formula 1-2 below, and even more particularly, may include the compound represented by Chemical Formula 1-1 below.

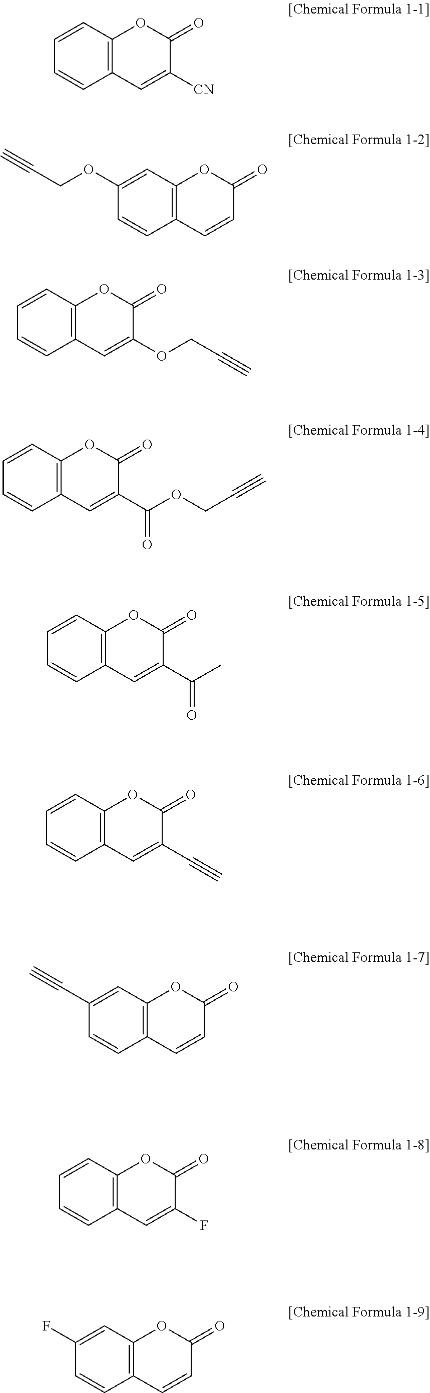

The compound represented by Chemical Formula 1 above may be included in an amount of 0.01 wt % to 10 wt %, particularly, 0.05 wt % to 5 wt %, more particularly 0.1 wt % to 1 wt %, and more particularly 0.3 wt % to 0.7 wt % in the non-aqueous electrolyte. With the amount of the compound represented by Chemical Formula 1 above, the effect of capturing reactive oxygen, generated during the initial formation previously described, may be sufficiently exhibited, and the risk of increase in resistance with excessive amounts being added may be prevented.

### 3) Compound Represented by Chemical Formula 2

The non-aqueous electrolyte according to the present disclosure includes a compound represented by Chemical Formula 2 below.

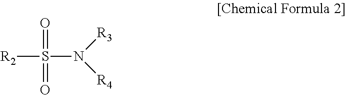

In Chemical Formula 2 above, R₂ is fluorine, a C1 to C10 alkyl group substituted with one or more fluorine, a C1 to C10 alkoxy group substituted with one or more fluorine, or a C6 to C20 aryloxy group substituted with one or more fluorine, and R₃ and R₄ are each independently hydrogen, a C1 to C10 alkyl group, or a C6 to C20 aryl group.

The compound represented by Chemical Formula 2 above is a sulfonamide-based compound including a substituent containing fluorine, which may improve oxidation stability of a solvent to a significant level when included in the non-aqueous electrolyte. In particular, since the compound represented by Chemical Formula 2 above improves the oxidation stability of the solvent during charging and discharging processes, rather than the initial formation process, an electrolyte side reaction is prevented, and the resulting gas generation is reduced to a significant level. Therefore, the non-aqueous electrolyte according to the present disclosure may suppress gas generation to a significant level during battery operation as well as the initial formation process, thereby significantly improving high-temperature storage characteristics, high-temperature lifetime characteristics, and resistance characteristics of a lithium secondary battery including perlithium manganese-rich oxide. Since the compound represented by Chemical Formula 2 above has minimal effect of capturing oxygen during the initial formation, generation of reactive oxygen that is the problem in the initial formation may not be prevented, so that the desired effect of the present disclosure may not be achieved without using the compound represented by Chemical Formula 1 in combination with the compound represented by Chemical Formula 2.

In addition, the compound represented by Chemical Formula 2 above may contain fluorine, and may thus provide an inorganic-type film, such as LiF, to an electrode upon decomposition. Since the inorganic-type film is combined with a polymer-type film derived from the compound represented by Chemical Formula 1 above, a film with improved flexibility, restorability, and durability at the same time may be formed on the electrode, thereby further improving high-temperature lifetime characteristics and high-temperature storage characteristics.

R₂ may be fluorine, a C1 to C10 alkyl group substituted with one or more fluorine, a C1 to C10 alkoxy group substituted with one or more fluorine, or a C6 to C20 aryloxy group substituted with one or more fluorine, particularly, fluorine or a C1 to C10 alkoxy group substituted with one or more fluorine, more particularly, fluorine or a C1 to C5 alkoxy group substituted with one or more fluorine, even more particularly, fluorine, CF₃O—, CF₃CF₂O—, or CF₃CH₂O—, and even more particularly, fluorine or CF₃CH₂O—.

R₃ and R₄ may be each independently hydrogen, a C1 to C10 alkyl group, or a C6 to C20 aryl group, particularly, hydrogen or a C1 to C5 alkyl group, more particularly a C1 to C5 alkyl group, and even more particularly, a methyl group.

In particular, the compound represented by Chemical Formula 2 above may include at least one of compounds represented by Chemical Formula 2-1 to Chemical Formula 2-5 below. More particularly, the compound represented by Chemical Formula 2 above may include at least one of the compounds represented by Chemical Formula 2-1 to Chemical Formula 2-3 below. Even more particularly, the compound represented by Chemical Formula 2 above may include at least one of the compounds represented by Chemical Formula 2-1 or Chemical Formula 2-2 below.

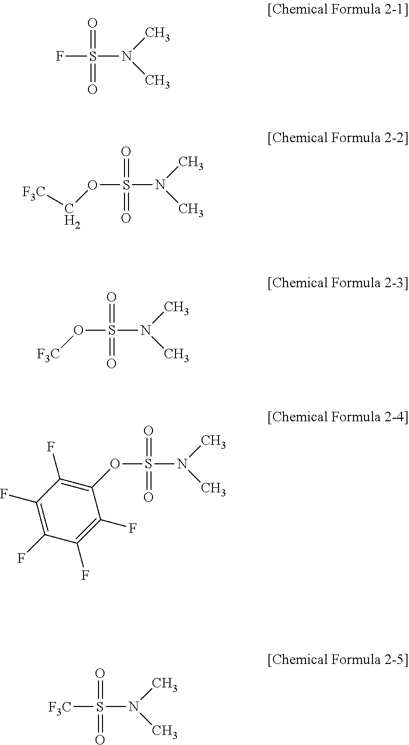

The compound represented by Chemical Formula 2 above may be included in an amount of 5 wt % to 40 wt %, particularly 8 wt % to 30 wt %, more particularly 10 wt % to 25 wt %, and even more particularly 15 wt % to 22 wt % in the non-aqueous electrolyte. In a case where the compound represented by Chemical Formula 2 above is included in the amount falling within the above range, oxidation stability of the solvent may be sufficiently improved, and the problem of decreased electrode impregnation due to increased viscosity of the non-aqueous electrolyte caused by excessive addition, the problem of decreased solubility of the non-aqueous electrolyte component such as an additive, and the like may be prevented.

Meanwhile, when the amount of the compound represented by Chemical Formula 2 above in the non-aqueous electrolyte is expressed as a volume percentage, the compound represented by Chemical Formula 2 may be included in an amount of 5 vol % to 40 vol %, and particularly 12 vol % to 25 vol % in the non-aqueous electrolyte.

The weight ratio of the compound represented by Chemical Formula 1 above and the compound represented by Chemical Formula 2 above may be 0.01:99.99 to 50:50, particularly 0.1:99.9 to 40:60, more particularly 0.2:99.8 to 30:70, even more particularly 0.5:99.5 to 10:90, even more particularly 0.5:99.5 to 7:93, and more particularly 2:98 to 4:96. When the ratio falls within the above ranges, excellent gas reduction effect may be exhibited on the whole during the initial formation and battery operation processes, previously described.

### 4) Organic Solvent

The non-aqueous electrolyte may further include an organic solvent together with the above-described components.

The organic solvent is a non-aqueous solvent generally used for a lithium secondary battery, and is not particularly limited as long as decomposition, caused by oxidation reaction, etc. may be minimized during charging and discharging processes of a secondary battery.

The organic solvent may be included in the non-aqueous electrolyte as a residue excluding the lithium salt, the compound represented by Chemical Formula 1, the compound represented by Chemical Formula 2, an additive selectively included, etc.

In particular, the organic solvent may include at least one of a cyclic carbonate-based organic solvent, a linear carbonate-based organic solvent, a linear ester-based organic solvent, or a cyclic ester-based organic solvent.

In particular, the organic solvent may include a cyclic carbonate-based organic solvent, a linear carbonate-based organic solvent, or a mixture thereof.

The cyclic carbonate-based organic solvent may be an organic solvent having high viscosity, which has high dielectric constant and thus is capable of dissociating a lithium salt in the electrolyte well, and may include at least one organic solvent of, particularly, ethylene carbonate (EC), fluoroethylene carbonate (FEC), propylene carbonate (PC), 1,2-butylene carbonate, 2,3-butylene carbonate, 1,2-pentylene carbonate, 2,3-pentylene carbonate, or vinylidene carbonate, more particularly, may include at least one of ethylene carbonate (EC) or fluoroethylene carbonate (FEC), and even more particularly, may include ethylene carbonate (EC).

In addition, the linear carbonate-based organic solvent may be an organic solvent having low viscosity and low dielectric constant, and may include at least one of, particularly, dimethyl carbonate (DMC), diethyl carbonate (DEC), dipropyl carbonate, ethylmethyl carbonate (EMC), methylpropyl carbonate, or ethylpropyl carbonate, more particularly, may include at least one of ethylmethyl carbonate (EMC) or diethyl carbonate (DEC), and even more particularly, may include ethylmethyl carbonate (EMC) and diethyl carbonate (DEC). In a case where the linear carbonate-based organic solvent includes the ethylmethyl carbonate (EMC) and diethyl carbonate (DEC), the ethylmethyl carbonate (EMC) and diethyl carbonate (DEC) may have a weight ratio of 50:50 to 99:1, particularly, 75:25 to 95:5, and more particularly, 80:20 to 90:10.

In particular, the organic solvent may include the cyclic carbonate-based organic solvent and the linear carbonate-based organic solvent.

When the organic solvent includes the cyclic carbonate-based organic solvent and the linear carbonate-based organic solvent, the compound represented by Chemical Formula 2 above and the organic solvent may have a weight ratio of 5:95 to 45:55, particularly, 10:90 to 35:65, and more particularly 15:85 to 25:75. When the ratio falls within the above range, effect of improving oxidation stability of the solvent may be further improved.

When the organic solvent includes the cyclic carbonate-based organic solvent and the linear carbonate-based organic solvent, the cyclic carbonate-based organic solvent and the linear carbonate-based organic solvent may have a weight ratio of 10:90 to 50:50, and particularly 20:80 to 40:60.

The linear ester-based organic solvent may include at least one of, particularly, methyl acetate, ethyl acetate, propyl acetate, methyl propionate, ethyl propionate, propyl propionate, or butyl propionate.

In addition, the cyclic ester-based organic solvent may include at least one of, particularly, γ-butyrolactone, γ-valerolactone, γ-caprolactone, σ-valerolactone, or ε-caprolactone.

Meanwhile, as the organic solvent, any organic solvent generally used for the non-aqueous electrolyte may be added and used as needed without limitation. For example, at least one organic solvent among an ether-based organic solvent, a glyme-based solvent, or a nitrile-based organic solvent may also be additionally included.

As the ether-based solvent, at least one of dimethyl ether, diethyl ether, dipropyl ether, methylethyl ether, methylpropyl ether, ethylpropyl ether, 1,3-dioxolane (DOL), or 2,2-bis(trifluoromethyl)-1,3-dioxolane (TFDOL), or a mixture of two or more thereof may be used, but an embodiment of the present disclosure is not limited thereto.

The glyme-based solvent may have higher dielectric constant and lower surface tension, and have fewer reactions with metal than the linear carbonate-based organic solvent, and may include at least one of dimethoxy ethane (glyme, DME), diethoxy ethane, diglyme, triglyme, or tetraglyme (TEGDME), but an embodiment of the present disclosure is not limited thereto.

The nitrile-based solvent may be at least one of acetonitrile, propionitrile, butyronitrile, valeronitrile, caprylonitrile, heptanenitrile, cyclopentane carbonitrile, cyclohexane carbonitrile, 2-fluorobenzonitrile, 4-fluorobenzonitrile, difluorobenzonitrile, trifluorobenzonitrile, phenylacetonitrile, 2-fluorophenylacetonitrile, or 4-fluorophenylacetonitrile, but an embodiment of the present disclosure is not limited thereto.

### 5) Additive

The non-aqueous electrolyte may further include an additive, together with the above-described components.

Particularly, the additive may be at least one selected from the group consisting of vinylene carbonate, vinyl ethylene carbonate, fluoroethylene carbonate, propane sultone, propene sultone, succinonitrile, adiponitrile, ethylene sulfate, lithium difluorooxalatoborate (LiODFB), lithium bis-(oxalato) borate (LiBOB), 3-trimethoxysilanyl-propyl-N-aniline (TMSPa), and tris(trimethylsilyl) phosphite (TMSPi).

The additive may be included in an amount of 0.1 wt % to 15 wt % in the non-aqueous electrolyte.

An outer shape of the lithium secondary battery of the present disclosure is not particularly limited, but may include a cylindrical type using a can, a prismatic type, a pouch type, a coin type, or the like.

Hereinafter, the present invention is described in more detail through particular examples. However, the following examples are only intended to aid understanding of the present invention, and the scope of the present invention is not limited thereto. It is obvious to those skilled in the art that various changes and modifications are possible within the scope and technical spirit of the present description, and it is natural that such changes and modifications fall within the scope of the appended claims.

### Example and Comparative Example

### Example 1

### (Preparation of Non-Aqueous Electrolyte)

The compound represented by Chemical Formula 1-2 above, the compound represented by Chemical Formula 2-1 above, LiPF₆ as a lithium salt, ethylene carbonate (EC), ethylmethyl carbonate (EMC), and diethyl carbonate (DEC) were mixed in a weight ratio of 0.5:18.5:14.0:20.0:39.5:7.5 to prepare a non-aqueous electrolyte.

### (Preparation of Lithium Secondary Battery)

A positive electrode active material (Li_{1.35}[Ni_{0.360}Co_{0.005}Mn_{0.635}]O₂, perlithium manganese-rich oxide):a conductive material (carbon nanotube):a binder (polyvinylidene fluoride) were added in a weight ratio of 96.0:1.5:2.5 to an N-methyl-2-pyrrolidone (NMP) solvent to prepare a positive electrode composite slurry (65 wt % solid content). The positive electrode composite slurry was applied onto one side of a positive electrode current collector (Al thin film) having a thickness of 12 μm, and dried and roll-pressed to prepare a positive electrode.

A negative electrode active material (a mixture of artificial graphite and natural graphite in a weight ratio of 50.3:49.7): a conductive material (carbon black): a binder (a styrene-butadiene rubber) were added in a weight ratio of 96.7:1.0:2.3 to a distilled-water solvent to prepare a negative electrode composite slurry (50 wt % solid content). The negative electrode composite slurry was applied onto one side of a negative electrode current collector (Cu thin film) having a thickness of 8 μm, and dried and roll-pressed to prepare a negative electrode.

A polyethylene porous film separator was disposed between the prepared positive electrode and negative electrode in a dry room, and then the prepared non-aqueous electrolyte was injected to prepare a secondary battery.

### Example 2

A lithium secondary battery was prepared in the same method as that of Example 1, except that the compound represented by Chemical Formula 1-2 above, the compound represented by Chemical Formula 2-1 above, LiPF₆ as a lithium salt, ethylene carbonate (EC), ethylmethyl carbonate (EMC), and diethyl carbonate (DEC) were mixed in a weight ratio of 1.0:18.5:14.0:20.0:39.0:7.5 to prepare a non-aqueous electrolyte.

### Example 3

A lithium secondary battery was prepared in the same method as that of Example 1, except that the compound represented by Chemical Formula 1-2 above, the compound represented by Chemical Formula 2-1 above, LiPF₆ as a lithium salt, ethylene carbonate (EC), ethylmethyl carbonate (EMC), and diethyl carbonate (DEC) were mixed in a weight ratio of 0.1:18.5:14.0:20.0:39.7:7.7 to prepare a non-aqueous electrolyte.

### Example 4

A lithium secondary battery was prepared in the same method as that of Example 1, except that the compound represented by Chemical Formula 1-2 above, the compound represented by Chemical Formula 2-1 above, LiPF₆ as a lithium salt, ethylene carbonate (EC), ethylmethyl carbonate (EMC), and diethyl carbonate (DEC) were mixed in a weight ratio of 0.5:27.0:14.0:20.0:31.0:7.5 to prepare a non-aqueous electrolyte.

### Example 5

A lithium secondary battery was prepared in the same method as that of Example 1, except that the compound represented by Chemical Formula 1-2 above, the compound represented by Chemical Formula 2-1 above, LiPF₆ as a lithium salt, ethylene carbonate (EC), ethylmethyl carbonate (EMC), and diethyl carbonate (DEC) were mixed in a weight ratio of 0.5:9.4:14.2:20.6:47.7:7.6 to prepare a non-aqueous electrolyte.

### Example 6

A lithium secondary battery was prepared in the same method as that of Example 1, except that the compound represented by Chemical Formula 1-1 above, the compound represented by Chemical Formula 2-1 above, LiPF₆ as a lithium salt, ethylene carbonate (EC), ethylmethyl carbonate (EMC), and diethyl carbonate (DEC) were mixed in a weight ratio of 0.5:18.5:14.0:20.0:39.5:7.5 to prepare a non-aqueous electrolyte.

### Example 7

A lithium secondary battery was prepared in the same method as that of Example 1, except that the compound represented by Chemical Formula 1-2 above, the compound represented by Chemical Formula 2-2 above, LiPF₆ as a lithium salt, ethylene carbonate (EC), ethylmethyl carbonate (EMC), and diethyl carbonate (DEC) were mixed in a weight ratio of 0.5:18.5:14.0:20.0:39.5:7.5 to prepare a non-aqueous electrolyte.

### Example 8

A lithium secondary battery was prepared in the same method as that of Example 1, except that the compound represented by Chemical Formula 1-3 above, the compound represented by Chemical Formula 2-1 above, LiPF₆ as a lithium salt, ethylene carbonate (EC), ethylmethyl carbonate (EMC), and diethyl carbonate (DEC) were mixed in a weight ratio of 0.5:18.5:14.0:20.0:39.5:7.5 to prepare a non-aqueous electrolyte.

### Example 9

A lithium secondary battery was prepared in the same method as that of Example 1, except that the compound represented by Chemical Formula 1-4 above, the compound represented by Chemical Formula 2-1 above, LiPF₆ as a lithium salt, ethylene carbonate (EC), ethylmethyl carbonate (EMC), and diethyl carbonate (DEC) were mixed in a weight ratio of 0.5:18.5:14.0:20.0:39.5:7.5 to prepare a non-aqueous electrolyte.

### Example 10

A lithium secondary battery was prepared in the same method as that of Example 1, except that the compound represented by Chemical Formula 1-6 above, the compound represented by Chemical Formula 2-1 above, LiPF₆ as a lithium salt, ethylene carbonate (EC), ethylmethyl carbonate (EMC), and diethyl carbonate (DEC) were mixed in a weight ratio of 0.5:18.5:14.0:20.0:39.5:7.5 to prepare a non-aqueous electrolyte.

### Example 11

A lithium secondary battery was prepared in the same method as that of Example 1, except that the compound represented by Chemical Formula 1-8 above, the compound represented by Chemical Formula 2-1 above, LiPF₆ as a lithium salt, ethylene carbonate (EC), ethylmethyl carbonate (EMC), and diethyl carbonate (DEC) were mixed in a weight ratio of 0.5:18.5:14.0:20.0:39.5:7.5 to prepare a non-aqueous electrolyte.

### Comparative Example 1

A lithium secondary battery was prepared in the same method as that of Example 1, except that LiPF₆ as a lithium salt, ethylene carbonate (EC), ethylmethyl carbonate (EMC), and diethyl carbonate (DEC) were mixed in a weight ratio of 14.5:21.0:56.8:7.7 to prepare a non-aqueous electrolyte.

### Comparative Example 2

A lithium secondary battery was prepared in the same method as that of Example 1, except that the compound represented by Chemical Formula 1-2 above, LiPF₆ as a lithium salt, ethylene carbonate (EC), ethylmethyl carbonate (EMC), and diethyl carbonate (DEC) were mixed in a weight ratio of 0.5:14.5:20.9:56.4:7.7 to prepare a non-aqueous electrolyte.

### Comparative Example 3

A lithium secondary battery was prepared in the same method as that of Example 1, except that the compound represented by Chemical Formula 2-1 above, LiPF₆ as a lithium salt, ethylene carbonate (EC), ethylmethyl carbonate (EMC), and diethyl carbonate (DEC) were mixed in a weight ratio of 18.6:14.1:20.4:39.4:7.5 to prepare a non-aqueous electrolyte.

### Experimental Example 1: Evaluation on Cycle Charging and Discharging Performance at High Temperature

150 cycles of charging and discharging, where 1 cycle refers to charging under conditions of CC/CV and 0.33 C at 45° C. to 4.35 V and 1/20 C, and then discharging under conditions of CC and 0.33 C to 2.5 V, were performed on the lithium secondary batteries prepared according to Examples 1 to 11 and Comparative Examples 1 to 3 as above, using an electrochemical charging and discharging instrument, and the capacity retention rate, the resistance increase rate, the amount of gas generation, and the amount of metal elution were evaluated.

### Experimental Example 1-1: Evaluation on Capacity Retention Rate

The charging and discharging were performed under the above conditions, then the capacity retention rate was calculated by the equation below, and the results were listed in Table 1 below.

$$Capacity retention rate ( \% ) = \{ ( discharge capacity after 150 cycles / discharge capacity after 1 cycle ) \} \times 100$$

### Experimental Example 1-2: Evaluation on Resistance Increase Rate

After 1 cycle of charging and discharging, using the electrochemical charging and discharging instrument, the discharge capacity after the 1 cycle was measured, SOC was adjusted to SOC 50%, and then 2.5 C pulse was applied for 10 seconds to calculate the initial resistance from a difference between a voltage before applying the pulse and a voltage after applying the pulse.

After 150 cycles of charging and discharging, the resistance after the 150 cycles was calculated in the same method as above, and using the equation below, the resistance increase rate was calculated, and the results were listed in Table 1 below.

$$Resistance increase rate ( \% ) = ( resistance after 150 cycles - initial resistance ) / initial resistance \times 100$$

### Experimental Example 1-3: Evaluation on Amount of Gas Generation

After charging and discharging under the above conditions, using gas chromatography mass spectrometry (GC-MS), the amount of gas generation was measured. The results were listed in Table 1 below.

### Experimental Example 1-4: Evaluation on Amount of Metal Elution

After charging and discharging under the above conditions, using an inductively coupled plasma optical emission spectrophotometer (ICP-OES), the concentration of the entire metal eluted in an electrolyte solution was measured. The amount of metal measured using the ICP analysis was listed in Table 1 below.

TABLE 1

| | | | Experimental | Experimental |
|---|---|---|---|---|
| | Experimental | Experimental | Example 1-3 | Example 1-4 |
| | Example 1-1 | Example 1-2 | Amount of | Amount of |
| | Capacity | Resistance | gas | metal |
| | retention | increase | generation | elution |
| | rate (%) | rate (%) | (μl) | (ppm) |
| Example 1 | 95.3 | 14.7 | 4200 | 230 |
| Example 2 | 94.1 | 16.8 | 4550 | 250 |
| Example 3 | 93.5 | 18.7 | 4600 | 240 |
| Example 4 | 93.1 | 20.1 | 4750 | 260 |
| Example 5 | 92.4 | 24.3 | 4950 | 310 |
| Example 6 | 91.8 | 23.8 | 4800 | 275 |
| Example 7 | 92.1 | 19.9 | 4900 | 320 |
| Example 8 | 90.5 | 19.3 | 4650 | 295 |
| Example 9 | 89.2 | 25.3 | 4500 | 340 |
| Example 10 | 91.7 | 24.1 | 6400 | 380 |
| Example 11 | 92.1 | 21.3 | 7500 | 410 |
| Comparative | 68.3 | 35.5 | 20150 | 590 |
| Example 1 | | | | |
| Comparative | 79.9 | 59.7 | 15850 | 510 |
| Example 2 | | | | |
| Comparative | 83.8 | 48.9 | 14680 | 495 |
| Example 3 | | | | |

Referring to Table 1, it can be seen that the lithium secondary batteries according to Examples 1 to 11, where perlithium manganese-rich oxide was used as a positive electrode active material, and all of the compounds represented by Chemical Formula 1 and Chemical Formula 2 were included in the non-aqueous electrolyte, had excellent lifetime performance, effect of reducing the resistance, low amount of gas generation, and low amount of metal elution during the cycle of charging and discharging, compared to those according to Comparative Examples 1 to 3 where they were not.

### Experimental Example 2: Evaluation on Storage Performance at High Temperature

The lithium secondary batteries prepared according to Examples 1 to 11 and Comparative Examples 1 to 3 as above were charged under conditions of CC/CV and 0.33 C at 25° C. to 4.35 V and 1/20 C, and discharged with 0.33 C to 2.5 V to perform initial charging and discharging, then charged under conditions of CC/CV and 0.33 C at 25° C. to 4.35 V and 1/20 C, and then stored at 60° C. for 8 weeks.

### Experimental Example 2-1: Evaluation on Capacity Retention Rate

After the storing, the secondary batteries were charged under conditions of CC/CV and 0.33 C at 25° C. to 4.35 V and 1/20 C and discharged with 0.33 C to 2.5 V. According to the equation below, the capacity retention rate was evaluated, and the results were listed in Table 2 below.

$$Capacity retention rate ( \% ) = ( Discharge capacity after 8 - week storage / initial discharge capacity ) \times 100$$

### Experimental Example 2-2: Evaluation on Resistance Increase Rate

In the initial charging and discharging, the capacity at room temperature was checked, then the secondary batteries were charged at SOC 50 based on the discharge capacity, and discharged with 3 C current for 10 seconds, and by the difference in voltage drop at this time, the resistance was measured as an initial resistance, and the resistance was measured in the same method after storage at 60° C. for 8 weeks as a final resistance, and the resistance increase rate was calculated therefrom using the equation below. The results were listed in Table 2 below.

$$Resistance increase rate ( \% ) = ( final resistance - initial resistance ) / ( initial resistance ) \times 100$$

### Experimental Example 2-3: Evaluation on Amount of Gas Generation

After the storing under the above conditions, using gas chromatography mass spectrometry (GC-MS), the amount of gas generation was measured. The results were listed in Table 2 below.

### Experimental Example 2-4: Evaluation on Amount of Metal Elution

After the storing under the above conditions, using an inductively coupled plasma optical emission spectrophotometer (ICP-OES), the concentration of the entire metal eluted in an electrolyte solution was measured. The amounts of metal measured using the ICP analysis were listed in Table 2 below.

TABLE 2

| | | | Experimental | Experimental |
|---|---|---|---|---|
| | Experimental | Experimental | Example 2-3 | Example 2-4 |
| | Example 2-1 | Example 2-2 | Amount of | Amount of |
| | Capacity | Resistance | gas | metal |
| | retention | increase | generation | elution |
| | rate (%) | rate (%) | (μl) | (ppm) |
| Example 1 | 94.2 | 19.8 | 3800 | 295 |
| Example 2 | 93.8 | 24.8 | 4100 | 325 |
| Example 3 | 93.2 | 23.3 | 4250 | 330 |
| Example 4 | 92.4 | 22.8 | 4380 | 320 |
| Example 5 | 92.8 | 24.1 | 4870 | 340 |
| Example 6 | 91.8 | 25.8 | 4950 | 365 |
| Example 7 | 89.9 | 26.9 | 5870 | 384 |
| Example 8 | 92.3 | 24.1 | 4750 | 350 |
| Example 9 | 91.5 | 28.3 | 5500 | 370 |
| Example 10 | 91.1 | 31.1 | 6350 | 410 |
| Example 11 | 88.3 | 24.8 | 5900 | 425 |
| Comparative | 43.8 | 45.8 | 8750 | 485 |
| Example 1 | | | | |
| Comparative | 58.6 | 39.7 | 6700 | 585 |
| Example 2 | | | | |
| Comparative | 61.8 | 41.8 | 6900 | 655 |
| Example 3 | | | | |

Referring to Table 2, it can be seen that the lithium secondary batteries according to Examples 1 to 11, where perlithium manganese-rich oxide was used as a positive electrode active material, and all of the compounds represented by Chemical Formula 1 and Chemical Formula 2 were included in the non-aqueous electrolyte, had excellent lifetime performance, effect of reducing the resistance, low amount of gas generation, and low amount of metal elution during the storage at high temperature, compared to those according to Comparative Examples 1 to 3 where they were not.

### Reference Example

### Reference Example 1

### (Preparation of Non-Aqueous Electrolyte)

A non-aqueous electrolyte was prepared in the same method as that of Example 1.

### (Preparation of Lithium Secondary Battery)

A positive electrode active material (Li[Ni_{0.6}Co_{0.1}Mn_{0.3}]O₂):a conductive material (carbon nanotube):a binder (polyvinylidene fluoride) were added in a weight ratio of 96.7:1.2:2.3 to an N-methyl-2-pyrrolidone (NMP) solvent to prepare a positive electrode composite slurry (65 wt % solid content). The positive electrode composite slurry was applied onto one side of a positive electrode current collector (Al thin film) having a thickness of 12 μm, and dried and roll-pressed to prepare a positive electrode.

A negative electrode active material (a mixture of artificial graphite and natural graphite in a weight ratio of 50.3:49.7): a conductive material (carbon black): a binder (a styrene-butadiene rubber) were added in a weight ratio of 96.7:1.0:2.3 to a distilled-water solvent to prepare a negative electrode composite slurry (50 wt % solid content). The negative electrode composite slurry was applied onto one side of a negative electrode current collector (Cu thin film) having a thickness of 8 μm, and dried and roll-pressed to prepare a negative electrode.

A polyethylene porous film separator was disposed between the prepared positive electrode and negative electrode in a dry room, and then the prepared non-aqueous electrolyte was injected to prepare a secondary battery.

### Reference Example 2

A lithium secondary battery was prepared in the same method as that of Reference Example 1, except that the non-aqueous electrolyte prepared in the same method as that of Comparative Example 2 was used.

### Reference Example 3

A lithium secondary battery was prepared in the same method as that of Reference Example 1, except that the non-aqueous electrolyte prepared in the same method as that of Comparative Example 3 was used.

### Reference Experimental Example 1: Evaluation on Cycle Charging and Discharging Performance at High Temperature

150 cycles of charging and discharging, where 1 cycle refers to charging under conditions of CC/CV and 0.33 C at 45° C. to 4.35 V and 1/20 C, and then discharging under conditions of CC and 0.33 C to 2.5 V, were performed on the lithium secondary batteries prepared according to Reference Examples 1 to 3 above using an electrochemical charging and discharging instrument, and the capacity retention rate, the resistance increase rate, the amount of gas generation, and the amount of metal elution were evaluated as below.

### Reference Experimental Example 1-1: Evaluation on Capacity Retention Rate

The charging and discharging were performed under the above conditions, then the capacity retention rates were calculated using the equation below, and the results were listed in Table 3 below.

$$Capacity retention rate ( \% ) = \{ ( discharge capacity after 150 cycles / discharge capacity after 1 cycle ) \} \times 100$$

### Reference Experimental Example 1-2: Evaluation on Resistance Increase Rate

After 1 cycle of charging and discharging, using the electrochemical charging and discharging instrument, the discharge capacity after the 1 cycle was measured, SOC was adjusted to SOC 50%, and then 2.5 C pulse was applied for 10 seconds to calculate the initial resistance by a difference between a voltage before applying the pulse and a voltage after applying the pulse.

After 150 cycles of charging and discharging, the resistance after the 150 cycles was calculated in the same method as above, and using the equation below, the resistance increase rate was calculated, and the results were listed in Table 3 below.

$$Resistance increase rate ( \% ) = ( resistance after 150 cycles initial resistance ) / initial resistance \times 100$$

### Reference Experimental Example 2: Evaluation on Storage Performance at High Temperature

The lithium secondary batteries prepared according to Reference Examples 1 to 3 as above were charged under conditions of CC/CV and 0.33 C at 25° C. to 4.35 V and 1/20 C, and discharged with 0.33 C to 2.5 V to perform initial charging and discharging, then charged under conditions of CC/CV and 0.33 C at 25° C. to 4.35 V and 1/20 C, and then stored at 60° C. for 8 weeks.

### Experimental Example 2-1: Evaluation on Capacity Retention Rate

After the storing, the secondary batteries were charged under conditions of CC/CV and 0.33 C at 25° C. to 4.35 V and 1/20 C, and discharged with 0.33 C to 2.5 V. According to the equation below, the capacity retention rate was evaluated, and the results were listed in Table 3 below.

$$Capacity retention rate ( \% ) = ( discharge capacity after 8 - week storage / initial discharge capacity ) \times 100$$

### Experimental Example 2-2: Evaluation on Resistance Increase Rate

In the initial charging and discharging, the capacities at room temperature were checked, then the secondary batteries were charged at SOC 50 based on the discharge capacity, and discharged with 3 C current for 10 seconds, and by the difference in voltage drop at this time, the resistance was measured as an initial resistance, and the resistance was measured in the same method after storage at 60° C. for 8 weeks as a final resistance, and the resistance increase rate was calculated therefrom using the equation below. The results were listed in Table 3 below.

$$Resistance increase rate ( \% ) = ( final resistance - initial resistance ) / \\ \\ ( initial resistance ) \times 100$$

TABLE 3

| | Reference Experimental | | Reference Experimental | |
|---|---|---|---|---|
| | Example 1 | | Example 2 | |
| | 1-1 | 1-2 | 2-1 | 2-2 |
| | Capacity | Resistance | Capacity | Resistance |
| | retention | increase | retention | increase |
| | rate (%) | rate (%) | rate (%) | rate (%) |
| Reference | 89.8 | 41.8 | 82.3 | 38.7 |
| Example 1 | | | | |
| Reference | 93.7 | 28.4 | 92.8 | 26.8 |
| Example 2 | | | | |
| Reference | 92.8 | 26.1 | 93.8 | 24.3 |
| Example 3 | | | | |

Referring to Table 3, it can be seen that the lithium secondary battery according to Reference Example 1, where the non-aqueous electrolyte including the compounds represented by Chemical Formula 1 and Chemical Formula 2 according to the present disclosure was applied to a positive electrode active material other than the perlithium manganese-rich oxide, had rather decreased performance in cycle charging and discharging and high-temperature storage, compared to those according to Reference Examples 2 and 3 where either one of the compound represented by Chemical Formula 1 or the compound represented by Chemical Formula 2 was only included in the non-aqueous electrolyte. This result appears to be because the positive electrode active materials used in Reference Examples 1 to 3 were less affected by deintercalation of reactive oxygen, and the increase in resistance due to the two compounds above being used in combination was more of a problem.

1. A lithium secondary battery comprising:
a positive electrode;
a negative electrode;
a separator disposed between the positive electrode and the negative electrode; and
a non-aqueous electrolyte,
wherein the positive electrode includes a positive electrode active material,
the positive electrode material includes a perlithium manganese-rich oxide containing about 50 mol % or more of Mn based on all metal elements excluding lithium, and having a molar ratio of lithium to all transition metals exceeding about 1, and
the non-aqueous electrolyte includes a lithium salt, a compound represented by Chemical Formula 1, and a compound represented by Chemical Formula 2: 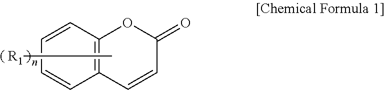
where, in Chemical Formula 1, R₁ is each independently a halogen, a nitrile group, a propargyl group, an ester group, an ether group, a ketone group, a carboxyl group, a substituted or unsubstituted alkyl group, a substituted or unsubstituted alkenyl group, a substituted or unsubstituted alkynyl group, a substituted or unsubstituted alkoxy group, a boron group, a borate group, an isocyanate group, an isothiocyanate group, a silyl group, a siloxane group, a sulfone group, a sulfonate group, a sulfate group, or a combination of two or more thereof, and n is an integer of 0 to 6, and 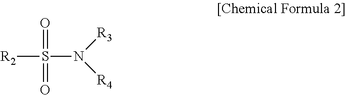
where, in Chemical Formula 2, R₂ is fluorine, a C1 to C10 alkyl group substituted with one or more fluorine, a C1 to C10 alkoxy group substituted with one or more fluorine, or a C6 to C₂₀ aryloxy group substituted with one or more fluorine, and R₃ and R₄ are each independently hydrogen, a C1 to C10 alkyl group, or a C6 to C20 aryl group.

2. The lithium secondary battery of claim 1, wherein the perlithium manganese-rich oxide comprises a compound represented by Chemical Formula A: 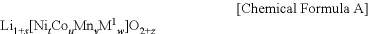
where, in Chemical Formula A, M¹ is one or more selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and
0.05≤s≤1, 0≤t≤0.5, 0≤u≤0.3, 0.5≤v<1.0, 0≤w≤0.2, and 0≤z≤1.

3. The lithium secondary battery of claim 1, wherein the compound represented by Chemical Formula 1 comprises at least one of a compound represented by Chemical Formula 1-A or a compound represented by Chemical Formula 1-B: 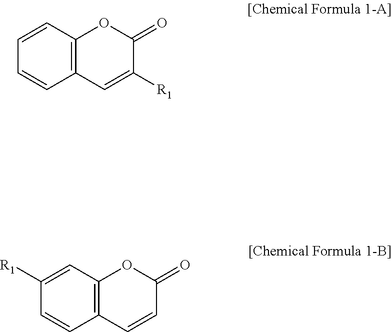
where, in Chemical Formula 1-A and Chemical Formula 1-B, R₁ is as defined in Chemical Formula 1.

4. The lithium secondary battery of claim 1, wherein the compound represented by Chemical Formula 1 comprises at least one of compounds represented by Chemical Formula 1-1 to Chemical Formula 1-9:

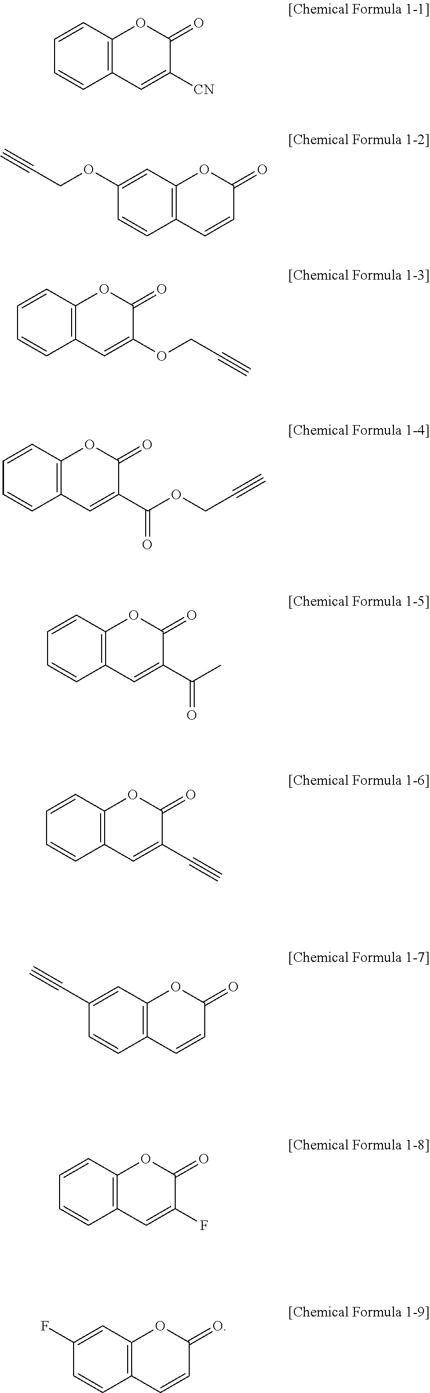

5. The lithium secondary battery of claim 1, wherein the compound represented by Chemical Formula 1 is included in an amount of 0.01 wt % to 10 wt % based on a total weight of the non-aqueous electrolyte.

6. The lithium secondary battery of claim 1, wherein the compound represented by Chemical Formula 2 comprises at least one of compounds represented by Chemical Formula 2-1 to Chemical Formula 2-5:

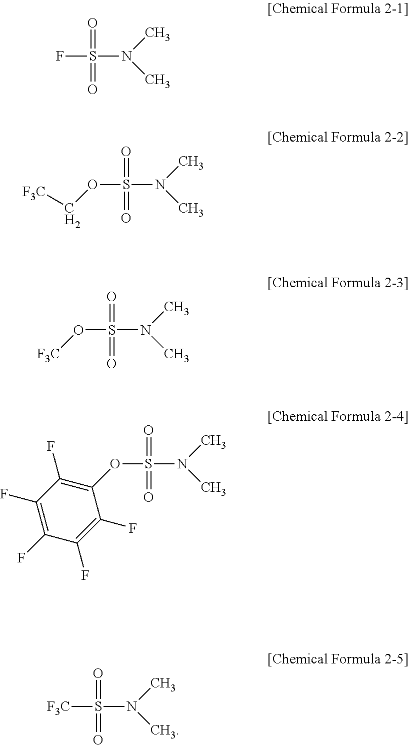

7. The lithium secondary battery of claim 1, wherein the compound represented by Chemical Formula 2 is included in an amount of 5 wt % to 40 wt % based on a total weight of the non-aqueous electrolyte.

8. The lithium secondary battery of claim 1, wherein a weight ratio of the compound represented by Chemical Formula 1 and the compound represented by Chemical Formula 2 is 0.01:99.1 to 50:50.

9. The lithium secondary battery of claim 1, wherein the lithium salt comprises at least one of LiCl, LiBr, LiI, LiBF₄, LiClO₄, LiAlO₄, LiAlCl₄, LiPF₆, LiSbF₆, LiAsF₆, LiB₁₀Cl₁₀, LiB(C₂O₄)₂ (LiBOB), LiCF₃SO₃, LiN(SO₂F)₂ (LiFSI), LiCH₃SO₃, LiCF₃CO₂, LiCH₃CO₂, or LiN(SO₂CF₂CF₃)₂ (LiBETI).

10. The lithium secondary battery of claim 1, wherein the non-aqueous electrolyte comprises an organic solvent, and
the organic solvent comprises at least one of a cyclic carbonate-based organic solvent, a linear carbonate-based organic solvent, a linear ester-based organic solvent, or a cyclic ester-based organic solvent.

11. The lithium secondary battery of claim 1, wherein the non-aqueous electrolyte further comprises at least one additive of vinylene carbonate, vinylethylene carbonate, fluoroethylene carbonate, propane sultone, propene sultone, succinonitrile, adiponitrile, ethylene sulfate, lithium bis-(oxalato)borate (LiBOB), lithium difluorooxalatoborate (LiODFB), tris (trimethylsilyl) phosphate (TMSPa), or tris(trimethylsilyl) phosphite (TMSPi).
